(19) United States
(12) Patent Application Publication
(10) Pub. No.: US 2010/0114714 A1
(43) Pub. Date: May 6, 2010

(54) METHOD AND SYSTEM FOR SHARING REVENUE OF AN APPLICATION PLATFORM

(76) Inventor: James Gerard Vitek, Ann Arbor, MI (US)

Correspondence Address: SCHOX PLC, 500 3rd Street, Suite 515, San Francisco, CA, 94107, US

(21) Appl. No.: 12/607,922

(22) Filed: Oct. 28, 2009

Related U.S. Application Data
(60) Provisional application No. 61/110,237, filed on Oct. 31, 2008.

(51) Int. Cl. G06Q 30/00; G06F 3/00

(52) U.S. Cl. 705/14.69; 715/745; 705/14.73; 705/14.7

(57) ABSTRACT

A method and system for sharing revenue of an application platform that includes the steps of providing a platform for managing a plurality of applications developed by a plurality of developers, collecting revenue through usage of the platform, tracking usage of the plurality of applications, and distributing revenue according to the tracked usage of the plurality of applications. The system including a client application included in a device platform for the operation of a plurality of applications, a tracking system that generates usage data for the plurality of applications, and a revenue engine that generates revenue and distributes revenue to platform contributors based on the usage data.

### CROSS-REFERENCE TO RELATED APPLICATIONS

This application claims the benefit of US Provisional Application number 61/110,237, filed 31 Oct. 2008, entitled “System and Method for an Advertisement Supported Mobile Application Platform”, which is incorporated in its entirety by this reference.

### TECHNICAL FIELD

This invention relates generally to the computer application platform field, and more specifically to a new and useful method and system sharing revenue of an application platform in the computer application platform field.

### BACKGROUND

Mobile phones have been internet enabled for many years. However, few subscribers regularly use the internet capabilities of a phone. The lack of standardized hardware and software severely limits the capabilities of an application provider to provide internet software to an audience large enough to be profitable. Additionally, the move towards alternative computing devices such as tablets and electronic books means that there are ever increasing operating systems, languages, and device features that an application developer has to manage. Each of these devices may additionally have their own methods of application distribution. These logistical and technical challenges prevent many applications from satisfying user needs and providing a profitable business strategy for the developer. Furthermore, the small screen size of mobile devices such as phones increases the usability cost of advertising on the devices. Applications already struggle to provide user-friendly interfaces with a limited screen area, and displaying an advertisement within an application only increases this challenge. As yet another point, users of mobile devices have in recent years become accustomed to low priced or even free applications for their mobile devices. This has left many developers struggling to justify the cost of producing high quality applications for mobile devices. Thus, there is a need in the application platform field to create a new and useful revenue sharing platform. This invention provides such a new and useful system and method for sharing revenue of an application platform.

### BRIEF DESCRIPTION OF THE FIGURES

FIG. 1 is a schematic diagram of the method for sharing revenue through an application platform according to a preferred embodiment of the invention;

FIG. 2 is a flowchart representation of one variation for dividing revenue;

FIG. 3 is a schematic diagram of the revenue sharing platform system according to a preferred embodiment of the invention; and

FIG. 4 is a schematic diagram of a content tile variation of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

1. Method for Sharing Revenue

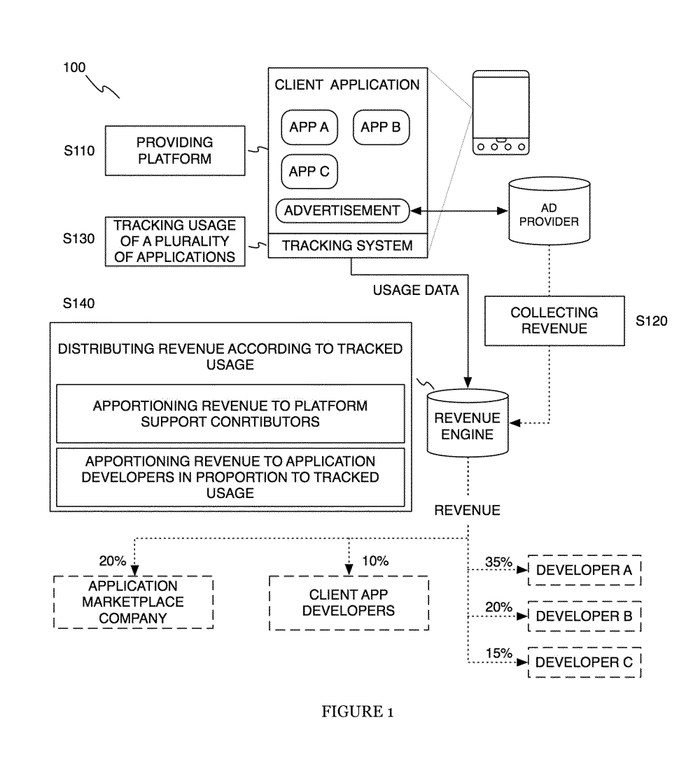

As shown in FIG. 1, a method 100 for sharing revenue of an application platform includes providing a platform for managing a plurality of applications developed by a plurality of developers Silo, collecting revenue through usage of the platform S120, tracking usage of the plurality of applications S130; and distributing revenue according to the tracked usage of the plurality of applications S140. The method 100 functions to provide applications to users, and to provide an enticing revenue sharing model for application developers, content providers, and service providers. The creation of an application platform for a computing device may be divided between multiple parties. The revenue sharing model preferably enables a single revenue source to support multiple parties contributing to content and resources. For an application platform on a mobile phone, a developer may need to create a client phone application for the specific phone model (specialized for the hardware and software of the phone), application developers preferably create applications, a network provider preferably provides access to a telephone or internet network, and an application marketplace may handle the distribution of applications. As shown in this example, there are multiple parties that each require motivation to provide their respective services and products. Method 100 provides the motivation for these parties to contribute to the application platform. The method 100 is preferably applied to mobile phones, but may alternatively or additionally be customized for any computing device such as a personal computer, a personal global positioning system, an electronic book reader, a television box set, a gaming platform, and/or any suitable device.

Step S110, which includes providing a platform for managing a plurality of applications developed by a plurality of developers, functions to provide users with the capability of running multiple applications. The management of applications preferably includes monitoring and/or running the application on a user device. The management of the applications may additionally include receiving an application from a developer of the application and/or delivering the application to a user device. Alternatively, applications may be distributed through outside application marketplaces such as the iPhone AppStore or the Android Market. In this alternative, the applications are preferably distributed with an embedded version of the platform, a subset of the platform, or in any other suitable manner. With an embedded platform the applications can be distributed in the same manner as applications that are not part of the revenue sharing platform. The applications are preferably offered through an application marketplace, preferably for free, but alternatively for purchase. The applications preferably are managed or run on a client application. The client application is preferably designed to run on a target device. For mobile phones, the client application may be designed for Java, BREW, Microsoft Windows Mobile, RIM (BlackBerry platform), Symbian, the Apple iPhone, Google Android, Access (Palm platform), and/or any suitable mobile phone platform. For computer devices, the client application may be part of an operating system, a background application, a website platform, or suitable program to run on the system. Additionally, the user experience and/or operation of the client application may be optimized for any suitable device. The client application additionally manages device specific buttons, touch screens, thumbwheels, cameras, speakers, microphones, accelerometers, GPS receivers, wireless, Bluetooth, headphones, screens, sensors, and/or any suitable device feature. The client application preferably displays the applications on a phone home-screen, but client application may alternatively be any program, a menu screen, a screen saver, idle screen, or any suitable program on a mobile device. All or part of the client application may additionally be provided as an embeddable portion of code that is run inside of an application.

In one preferred embodiment, the applications are widget like applications (or content tiles) on a mobile device. The content tiles are preferably applications that provide text, images, graphics, animations, videos, interactive interfaces, and/or any suitable media to provide information to a user on topics such as weather, news, sports, photos, RSS feeds, social network information, static information, phone data, messaging information, and/or any suitable information. The content tiles function to provide a relevant home-screen for device users. The content tiles may alternatively be non-visual background/alert programs, phone applications, or any suitable mobile application. Multiple content tiles are preferably run and displayed at the same time (such as in a tiled format or a windowing format), but alternatively only one content tile may be actively run, multiple screens of content tiles, overlapping content tiles, timed rotation of content tiles, situation or geolocation-specific content tiles, time dependent content tiles, or any suitable alternatives to the display of content tiles may be implemented.

Step S120, which includes collecting revenue through usage of the platform, functions to monetize the product and services provided by the platform. The revenue may be generated in a variety of ways. Preferably, step S120 includes delivering advertisement through an advertisement application within the platform. The advertisement application preferably provides a graphic link on the device screen but may alternatively be audio, video, text, and/or any suitable medium of advertising. The advertisement application preferably allows a user to be directed to an advertisers website, play a video clip, play an audio clip, or perform any suitable advertisement task. Advertisement revenue is preferably obtained by CPC/cost-per-click, CPM/Cost-Per-thousand impressions and/or CPA/cost-per-acquisition strategies or any suitable advertising model. Revenue is preferably generated when a user clicks on the advertisement to link to a webpage, view a video, listen to audio, view an image, interact with an advertisement, or any suitable form of advertisement. The advertisement application is preferably delivered on a default screen such as an idle screen, a so-called “home” screen (or “default” screen), or a menu screen. The advertisement may alternatively be a banner advertisement that is displayed alongside other applications, in platform menu screens and/or during the operation of applications. The advertisement is preferably provided from Google AdSense, Yahoo, MSN, Admob, or any suitable advertisement provider. Advertisements may alternatively be stored locally, obtained directly from advertisers, or obtained in any suitable manner. New advertisements may be based on applications, usage data, geographic location, time of day, a user profile, user emails or text messages, web browsing, or on any suitable data. Alternatively, step S120 may include receiving user subscription fees. In this alternative, the user preferably pays a fee and as part of the fee, the user is granted access to the applications of the platform. The subscription may be to the platform itself or may alternatively be part of another subscription such as a telephone service fee or as part of any suitable membership or purchase. As another alternative, the platform may be supported by the sale of other products such as digital music, video, and/or media. As yet another option, the applications may have a variety of options for a user: an application may be purchased directly, may elect to use an advertisement-enabled version of the application, or try a temporary trial demo of the application. In this variation, Step S120 preferably uses a user-selected method of revenue generation for an application. Additionally the revenue may be collected from any combination of advertising, subscriptions, user purchases, or other suitable revenue models.

Step S130, which includes tracking usage of the plurality of applications, functions to monitor and record data that can be used as a metric for the value an application provides to a user. Usage data is preferably tracked for each application of the plurality of applications on the platform. The usage data is preferably used during the revenue dividing process in determining what portion of revenue the developers of the application should receive. Step S130 may include tracking a user setup of an application. User setup preferably includes any configuration for the display, accessibility, ordering/positioning of the application in context of the platform. For example, user setup may include customizing a system home-screen by adding, removing, arranging, setting dimensions, alert settings, altering settings, and/or any other adjustments to the applications of the platform. In one embodiment, the tracking of user setup includes tracking tile dimensions of content tiles (e.g., window or widget size) at the time of viewing of an advertisement. The tile dimensions (or screen percentage) are preferably tracked for each advertisement a user views. The usage setup may also include tracking the application order, such as when applications are displayed in a list, a menu, or on ordered pages. Alternatively or additionally, the tracking of content tiles may include tracking user interaction with an application. Tracking user interaction may include recording the number of times or frequency an application is opened, the amount of time an application is opened (i.e., elapsed time), the number of installations, number of application deletions, user satisfaction (e.g., through application reviews or ratings), or any suitable combination or alternative way of quantifying the user interaction with an application. The usage interaction may be an absolute value or be relative to other applications used by a user. Additionally, usage data may include relevance of an application (as it relates to the advertisements), or any suitable data that can be used in the revenue splitting process. The tracked usage data is preferably tracked for each device with the platform, and combined to calculate overall usage data for applications used on a plurality of devices. The tracked usage data is preferably collected from multiple users to form the overall usage data for an application.

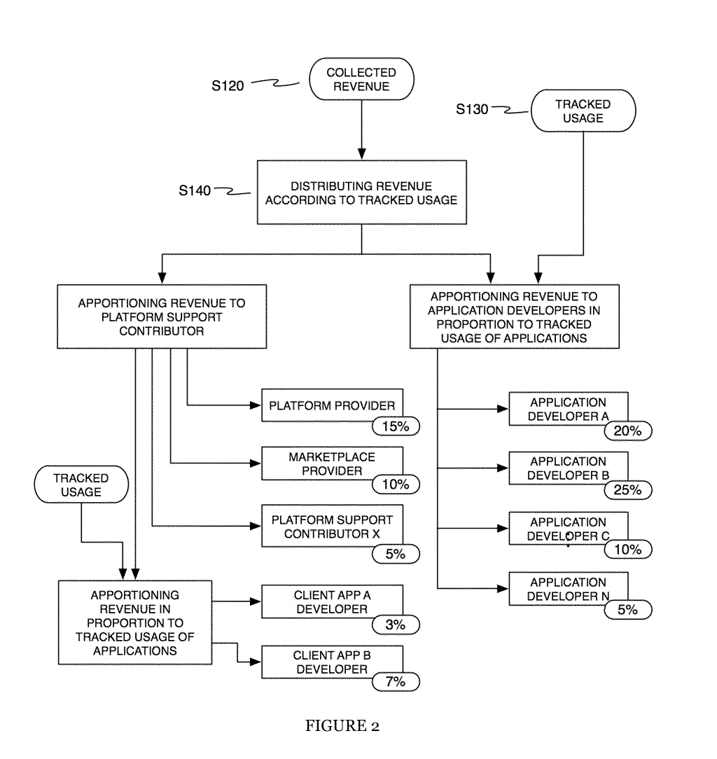

As shown in FIG. 2 Step S140, which includes distributing revenue according to the tracked usage of the plurality of applications, functions to use relevant information of how a user uses a platform to disperse the accumulated revenue of the platform to the parties that provided services or products to enable the platform. The revenue is preferably apportioned (i.e., divided and allocated) at least in part to application developers of the applications on the platform in proportion to the tracked usage of the respective applications of the application developers. This usage-based revenue sharing functions to reward application developers that develop valuable applications. Applications with better usage results (e.g., frequent use by users or user setup indicating higher preference) preferably receive more revenue than an application with poorer usage results (e.g., less frequent use by users or user set up indicating lesser preference).

More preferably, the distributing of revenue includes apportioning a portion of the revenue to a platform support contributor according to a contract, and apportioning a portion of the revenue to application developers in proportion to the tracked usage of the respective applications of the application developers. The platform support contributors may include any party that provides a service or product that aids in the functioning of the platform. The platform support contributors may include platform providers, application developers, application marketplace providers, network providers, device companies, distribution partners (e.g. phone carrier company, website, or other partners of the platform), and/or any suitable entity. Platform support contributors are preferably apportioned revenue according to a contract. The contract may specify a fixed fee, a percentage of revenue, or any suitable financial agreement. Alternatively, platform support contributors may receive revenue in proportion to tracked usage in a fashion substantially similar to the application developers. For example, a client application provider may receive a portion of revenue based on the tracked usage of applications in comparison to the usage on other client applications. In this way, the platform support contributors are motivated to enhance the client applications for the users.

In one example, advertisement revenue is divided as follows: application developers 50%, mobile system provider 16.6%, client application 16.6%, and distribution channel 16.6%. In one variation of this example, screen real estate usage data (user setup) is used. There may be 5 application developers where the applications of companies A, B, and C occupy 25% of the screen each; the application of company D occupies 10% of the screen; and the application of company E occupies 5% of the screen. The 50% of revenue apportioned to the application developers is further divided as follows: company A 25%, company B 25%, company C 25%, company D 10%, and company E 5% as determined by their tile dimensions. In another variation of this example, user interaction usage data is used. For this example application A, B and C may be used 25 times, application D 15 times, and application E 10 times. The 50% of the revenue apportioned for application developers would be further apportioned to the application developers as follows: application developer A 25%, application developer B 25%, application developer C 25%, application developer D 15%, and application developer A 10%.

2. System for Revenue of a Platform

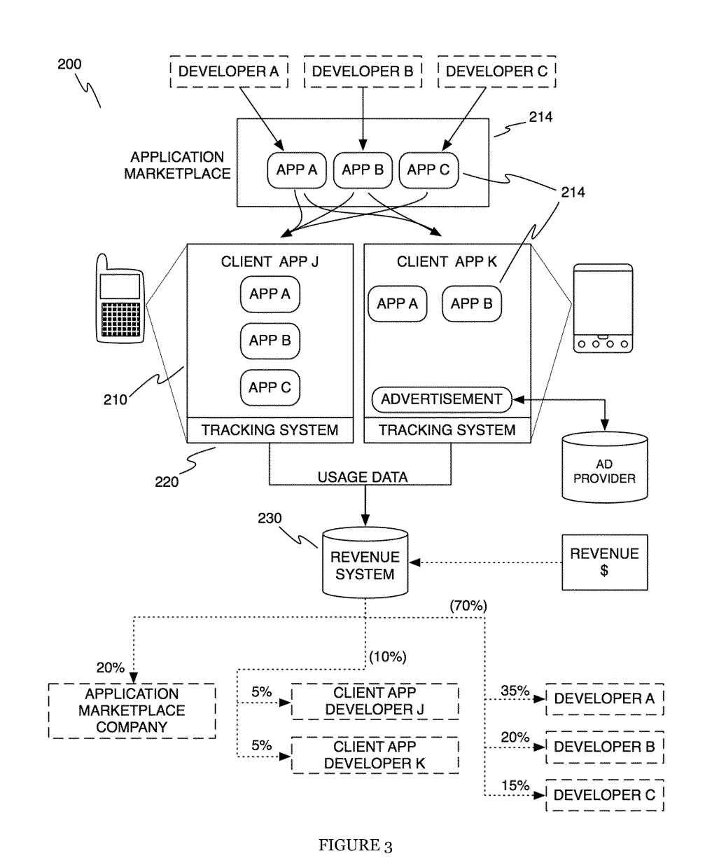

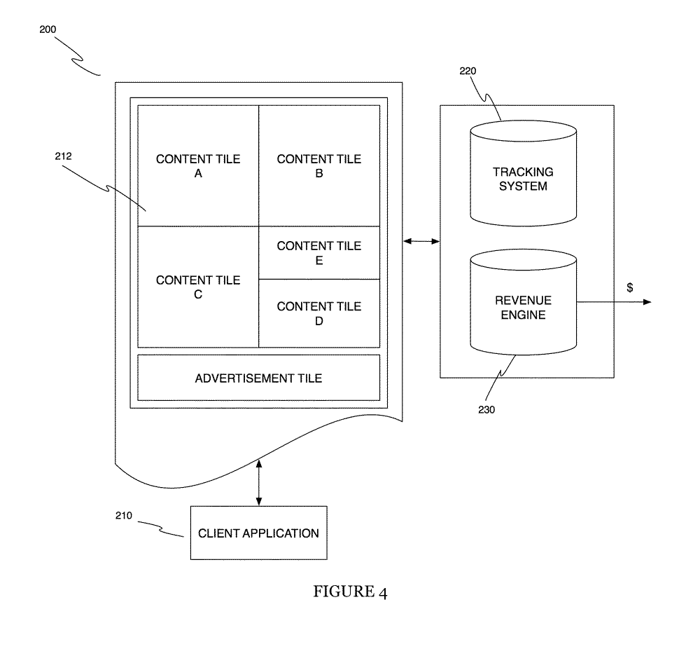

As shown in FIG. 3 and 4, the system 200 for sharing revenue of an application platform of the preferred embodiment includes a client application 210, an application tracking system 220, and a revenue engine 230. The system 200 functions to provide an improved device application environment for the user, while providing a profitable development field for application development companies. The system 200 is preferably presented to a user as a home screen interface on a device (e.g., a phone) that has various applications 212, which may function as standalone applications or informative widgets. In one embodiment the client application 210 is enabled to feed applications 212 with content so that the applications 212 function as content tiles or widgets. The system 200 preferably has a design that allows for integration of advertisements into the interface, and the home screen interface also provides a novel way of dividing revenue based on configuration and/or usage of the interface and/or applications. The system 200 may alternatively or additionally enable the generation of revenue through other methods such as subscriptions or purchases.

The client application 210 of the preferred embodiment functions as the main software application running on a device that displays content, manages phone inputs and outputs, data management, and any suitable aspects of an application. The client application 210 preferably manages any process tasks on a device to enable the revenue sharing platform system 200. The client application 210 is preferably customized for a phone model and/or a phone platform. The client application 210 may be customized to operate on Java, BREW, Microsoft Windows Mobile, RIM (BlackBerry platform), Symbian, the Apple iPhone, Google Android, Access (Palm platform), and/or any suitable mobile phone platform. The client application 210 may alternatively be designed for any suitable computing device such as a personal computer, a global positioning system, an electronic book reader, television box set, gaming platform, in-car dashboard, and/or any suitable device. There is preferably a plurality of types of client applications 210 so that the system for revenue sharing may be brought to a wide range of users with different devices. The client application 210 may additionally be customized to use any available features provided by a device, such as device specific buttons, touch screens, thumbwheels, cameras, speakers, microphones, accelerometers, GPS, wireless, Bluetooth, headphones, screens, sensors, USB ports, media card readers, CD/DVD drives, and/or any suitable feature. The client application 210 may alternatively be a user interface shell of a device operating system. The client application may additionally be a portion of code or embedded program that can be included within an application 212, such that the application 212 runs on a native platform but the client application 210 manages any required platform tasks such as application tracking and revenue generation (e.g., displaying advertisements). The client application 210 preferably manages the operation of the applications 212, and displays the applications 212 on a home screen. The client application 210 may alternatively organize or run the applications 212 in any suitable manner. The client application 210 may additionally provide an interface for a user to customize the applications 212 by adding, removing, arranging, setting dimensions, editing settings, and/or any other adjustments to the applications of the platform. Application setup may alternatively be dictated through a device-native system, a web service, or any suitable system. The client application 210 may additionally include a data service that functions to manage incoming data and account for slow and/or intermittent data. The data service preferably caches information or data used by the client phone application or content tiles. The client application 210 may be developed and provided by any suitable party. The revenue sharing aspects of the system preferably provides an incentive to develop client applications 210 for a wide variety of devices.

The applications 212 of the preferred embodiment function to provide information or program interactions on a device. The applications 212 preferably provide any suitable functionality, such as an address book, calendar, game, messaging system, VoIP client, business application, or any suitable program application. The applications 212 may use resources made available on the device. The applications 212 may use network access through internet, telephone network, SMS, or any suitable data infrastructure. The applications 212 may be organized from a device menu or launched from any suitable interface. Applications are preferably distributed through an application marketplace 214, which functions to be a collection of applications from which a user may select applications to install on a device. The marketplace 214 preferably distributes the applications for free, but may alternatively require a subscription fee or a purchase fee depending on the revenue model employed by the revenue engine 230. The application marketplace 214 may additionally provide options to the user so they can purchase an application, acquire a advertisement-supported version, subscribe to a service to acquire the application, acquire a limited demo of the application, or any suitable way of acquiring the application 212.

The application tracking system 220 functions to track usage of a plurality of applications. The tracking system 220 preferably tracks the usage of applications 212 on individual devices (for single users) and aggregates the data for global platform usage (by multiple users). The tracking system preferably generates data to evaluate the usage of applications, but may additionally generate data related to the revenue source (e.g., advertisements), the client application, application marketplace, and/or any suitable aspects of the platform that may support the revenue sharing process. The tracking system 220 preferably tracks user setup and/or user interaction. User setup may include any configuration for the display, accessibility, ordering/positioning of an application or settings of the client application 210. User interaction may include the number of times or frequency an application 212 is opened, the amount of time an application 212 is opened, the number of installations, number of application deletions, user satisfaction (e.g., reviews or ratings), or any suitable way of quantifying the user interaction with an application 212. In the embodiment using content tiles, the tracking system 220 preferably tracks the tile dimension of each content tile (i.e., user setup). This user setup may additionally be correlated to revenue generation such as the dimensions of a content tile when and advertisement was clicked. The tile dimension is preferably used in the division of advertisement revenue amongst the various parties.

The revenue engine 230 of the preferred embodiment functions to collect revenue through the platform and distribute the revenue at least in part based on data generated by the tracking system 220. The revenue source may be achieved in a variety of ways. Preferably, advertisements are displayed on a device in exchange for use of the applications. The client application 210 preferably manages the advertisements. An advertisement may be displayed on an idle screen, as a banner ad, within an application, or in any suitable form or time. Advertisements are preferably collected from advertisement providers such as Google AdSense, Yahoo, MSN, Admob, or any suitable advertisement provider. The advertisements may alternatively be provided by any suitable means. The advertisement preferably changes periodically. The advertisement may alternatively change based on device usage, location, application interaction, or any suitable factor. The content of the advertisement may additionally be customized for the user, preferably by using information from applications, geographic location, time of day, a user profile, user emails or text messages, web browsing, or on any suitable data. Advertisement revenue is preferably received based on a CPC/cost-per-click strategy, CPM/Cost-Per-thousand impression strategy, CPA/cost-per-acquisition strategy, and/or any suitable method. The revenue engine 230 may alternatively generate revenue through subscription fees. The revenue engine 230 receives payment from a user, and in exchange, the user is allowed to use the platform and preferably use the applications for free (or at a reduced price). The revenue engine 230 may alternatively collect revenue through the sale of products such as multimedia. The revenue engine 230 may alternatively generate revenue through any suitable device.

The revenue engine 230 additionally apportions the revenue to various parties at least in part based on the usage data of the tracking system 220. The revenue preferably divides revenue and distributes the appropriate funds to parties involved in the platform. The revenue preferably apportions the revenue in a manner substantially similar to Step S140 described above.

In one preferred embodiment shown in FIG. 4, the applications 212 are content tiles (widget like applications) displayed on a phone screen, or more preferably a home screen (also known as a default screen, idle screen, or main screen), arranged in a mosaic or tiled pattern. The content tiles preferably run within the client application, but alternatively could be operated in any suitable environment and by any suitable application. While each individual content tile is preferably a unique application, a content tile could have any number of instances. The content tile preferably has a tile dimension and location within the phone screen. The tile dimension is preferably set by a percentage or alternatively a width and height, a block size, or any suitable dimension parameter. The content tile preferably has content adapted for being displayed in a given tile dimension, and preferably adapts to a specified dimension. Though alternatively, a content tile may have one or a limited number of content tile dimensions. The content tiles are preferably displayed fully (not overlapping) on the screen, but multiple screens of content tiles, overlapping content tiles, an individual content tile, windowing system of content tiles, timed rotation of content tiles, situation-specific content tiles, location-dependent content tiles, time-dependent content tiles, event-dependent content tiles, or any suitable alternatives to the display of content tiles may be implemented. The content tile preferably provides text, images, graphics, animations, videos, interactive interfaces, and/or any suitable media. The content tile is preferably used in applications that provide information to a user on topics such as weather, news, sports, photos, RSS feeds, social network information, static information, phone data, messaging information, and/or any suitable information. Additionally, a content tile may include non-visual functionality such as an alert and/or background program that operates based on data events (e.g. RSS feed updates, stock price changes, sport scores), time of day (e.g. calendar reminder), location (e.g. shopping list reminders, restaurant/store ratings, friend location), aggregated push data (e.g. speed tracking and road condition prediction based on aggregated data), and/or any suitable application.

In the content tile embodiment, advertising is a preferred source of revenue, though any suitable alternative source of revenue may be used. The system preferably includes at least one advertisement content tile that functions to provide an advertisement revenue source for services, functionality, and/or information provided by mobile system provider, content tile providers, distribution partners (e.g. a phone carrier company, a website, or other suitable providers of the mobile system), client application developers, advertisement suppliers, and/or any suitable party. The ad-content tile preferably enables multiple content tiles (and any services, functionality, and/or information they provide) to be supported by a single advertisement. The advertisement tile preferably has a minimum tile dimension. Though, any suitable rules defining the advertisement content, the tile dimension, location, or any suitable aspect of the advertisement tile may be implemented

As a person skilled in the art will recognize from the previous detailed description and from the figures and claims, modifications and changes can be made to the preferred embodiments of the invention without departing from the scope of this invention defined in the following claims.

We claim:

1. A method for sharing revenue of an application platform comprising:
providing a platform that manages a plurality of applications developed by a plurality of developers;
collecting revenue through usage of the platform;
tracking usage of the plurality of applications; and
distributing revenue according to the tracked usage of the plurality of applications.

2. The method of claim 1, wherein the platform that manages the plurality of applications performs the tasks of:
receiving an application from an application developer;
delivering an application to a user device; and
monitoring the application on the user device.

3. The method of claim 2, wherein the step of delivering an application to a user device includes delivering an application to a mobile phone.

4. The method of claim 1, wherein at least a subset of the plurality of applications is developed by a singular developer of the plurality of developers.

5. The method of claim 1, wherein the step of distributing revenue includes apportioning a portion of the revenue to an application developer in proportion to the tracked usage of the application developed by the application developer.

6. The method of claim 5, wherein the step of tracking usage of the plurality of applications includes tracking a user setup of an application.

7. The method of claim 6, wherein the step of tracking a user setup of an application includes recording a value based on the application window size.

8. The method of claim 5, wherein the step of tracking usage of the plurality of applications includes tracking user interaction with an application.

9. The method of claim 8, wherein the step of tracking user interaction with an application includes recording a value based on the number of times the application is launched by a user.

10. The method of claim 1, further comprising delivering advertisements through an advertisement application within the platform, wherein the step of collecting revenue uses the advertisements as a revenue source.

11. method of claim 10, wherein the step of delivering advertisements through an advertisement application within the platform includes displaying advertisements on a default view of the platform.

12. The method of claim 1, wherein the step of collecting revenue includes collecting revenue from a user paid subscription.

13. The method of claim 1, wherein the step of distributing revenue further includes apportioning a portion of revenue to at least one platform support contributor according to a contract, and apportioning a portion of the revenue to application developers in proportion to the tracked usage of the respective applications of the application developers.

14. The method of claim 13, wherein the step of distributing revenue further includes apportioning a portion of revenue to at least one platform support contributor in proportion to the tracked usage of the applications.

15. The method of claim 13, wherein platform support contributors include platform providers, an application marketplace provider, and distribution partners.

16. The method of claim 1, further comprising:
delivering advertisements through an advertisement application within the platform;
apportioning a portion of revenue to platform support contributors according to a contract;
apportioning a portion of the revenue to application developers in proportion to the tracked usage of the respective applications of the application developers; and
wherein the platform is run on a mobile phone.

17. The method of claim 16, wherein the step of tracking usage of the plurality of applications includes recording the application window size.

18. The method of claim 16, wherein the step of tracking usage of the plurality of applications includes tracking user interaction with an application.

19. The method of claim 1, wherein the step of collecting revenue further includes using a user-selected method of revenue generation for an application.

20. A system for sharing revenue of an application platform comprising:
a client application included in a device platform for the operation of a plurality of applications;
a tracking system that generates usage data for the plurality of applications; and
a revenue engine that generates revenue and distributes revenue to platform contributors in proportion to usage data.

21. The system of claim 20, wherein the client application is run on a mobile phone.

22. The system of claim 21, further comprising:
a plurality of applications that are content tiles displayed in a mosaic pattern on a screen;
an advertising application that is one of the plurality of content tiles and that is in communication with an advertisement provider and the revenue engine; and
wherein the tracking engine generates usage data related to the dimensions of the content tiles.
